(19) United States
(12) Patent Application Publication
(10) Pub. No.: US 2015/0359384 A1
(43) Pub. Date: Dec. 17, 2015

(54) BAKED FOOD APPARATUS AND METHOD

(71) Applicant: Randy Lee Garbrick, Shoreline, WA (US)

(72) Inventor: Randy Lee Garbrick, Shoreline, WA (US)

(21) Appl. No.: 14/741,470

(22) Filed: Jun. 17, 2015

Related U.S. Application Data
(60) Provisional application No. 62/012,989, filed on Jun. 17, 2014.

(51) Int. Cl. A47J 37/01; A21D 13/00

(52) U.S. Cl. CPC A47J 37/01; A21D 13/0087

(57) ABSTRACT

A method and apparatus for baking and displaying multiple cupcakes having a merged top surface allowing them to be decorated with a single shared decoration. The baking apparatus may have an upper pan part and a lower pan part. The upper pan part may have a perimeter sidewall to guide the creation of the merged top surface during baking. The lower pan part may support the bottom portion of the cupcake during baking. A cover and display apparatus may be provided to protect the cupcakes and provide a means to display the cupcakes. The cover and display apparatus may have an array of pedestals on the top surface. The top portion of the baking pan, holding the completed cupcakes, may be placed on top of the pedestals and may be pressed down over the pedestals, leaving cupcakes supported for display on top of the pedestals.

### BACKGROUND

The present disclosure describes a method of baking cupcakes or muffins in such a manner that the top portions of each individual cupcake or muffin merges to form a single surface that can be decorated in a similar manner to a sheet cake. The present disclosure also includes a baking apparatus to support the cupcakes of muffins and guide the creation of a merged top surface during baking. In addition, a covering and serving apparatus is described that performs multiple functions, including protecting the decorated merged top surface of the cupcakes or muffins and securing the multiple parts of the baking apparatus during transport, providing a means to easily remove the cupcakes or muffins from the baking apparatus and providing a display surface for easy serving. While this disclosure is directed towards cupcakes and muffins, it can also be used for other edible item as well as non-edible decorative or construction uses. Many additional applications are contemplated and obvious to one skilled in the art.

Cupcakes and muffins have historically been created as individual servings having the lower portion covered by a liner for ease of handling. The process of decorating these individual servings one by one could become tedious and because of the small surface area, creating larger written messages or pictures could be difficult.

### SUMMARY

The present invention is related to a pan for baking baked goods, such as cupcakes. The pan provides improved characteristics to the resulting baked good by causing the tops of the cupcakes to merge together into a single surface, similar to a cake, during baking, for the purpose of decoration and ease of serving. This same pan can be used for storing and shipping the baked good or the uncooked batter or dough by adding a cover to the pan. Two of the preferred pans include a feature which allows the cupcakes to be removed from the pans without inversion.

The pan according to the present invention has a perimeter wall that extends above the main surface of the pan. This wall extends above the level of the batter or dough in the pan and preferably extends above the main surface of the pan. This wall extends above the level of the batter or dough in the pan and preferably extends above the level of the final baked product in the pan and acting as a form for the combined surface.

Creating the desired merged top surface may require reducing the spacing between the cupcake baking cups to a minimum. This is accomplished in one embodiment by retaining the circular shape of the cupcake liner at the bottom surface of the baking cup while gradually transitioning the shape of the baking cup to a square at the top surface of the baking cup. This allows the top edges of the baking cups to be positioned closely together with very little intervening space. As the cupcakes bake and increase in volume, they overflow the top edge of the baking cup, the excess merges together to create the merged top surface and this excess is guided into a proper shape by raised walls on the outside edges of the baking apparatus. Previous cupcake baking methods retained the circular shape at the top surface of the baking cup and provided ample spacing between individual cups in the support structure to ensure that the cupcake top portions would not contact each other. Thus, these prior methods required a much larger baking apparatus than the present disclosure.

Reducing the space between the top edges of the baking cups also has the benefit of reducing the contact area between the top portion of the cupcake or muffin that is outside of the cupcake liner and the top surface of the baking apparatus, thus making the cupcakes easier to remove from the baking apparatus. In previous cupcake baking methods, the large spacing between the individual baking cups allowed any overflow to directly contact the top surface of the baking apparatus, greatly increasing the likelihood of the cupcake top sticking to the top surface of the baking apparatus and either being difficult to remove or being damaged upon removal.

Creating a merged top surface for multiple cupcakes requires a method to remove all of the cupcakes from the baking apparatus simultaneously. This is accomplished in one embodiment by a baking apparatus in which the filled cupcake liner is supported during baking by a removable bottom portion and the top merged top surface is supported by a separate top portion, the top portion having small flanges to support the lined bottom portion of the cupcake when the bottom support apparatus is removed. The top portion of the baking apparatus, containing the merged top surface of the cupcakes with the lined portion protruding from the bottom is then placed on top of a serving apparatus that is comprised of an array of pedestals of a proper number and shape to support all of the cupcakes and pass through the openings in the top portion of the baking apparatus. The top portion of the baking apparatus is then pressed down over the display pedestals to force the cupcakes and the merged top surface out of the top portion of the baking apparatus. These pedestals may be of sufficient height to allow the bottom of the cupcake to be supported above the level of the outer wall of the top portion of the baking apparatus for easy removal.

### BRIEF DESCRIPTION OF THE DRAWINGS

FIG. 1 is a perspective view of a cupcake pan embodiment according to the present invention, including a bottom supporting part, a separable top part that provides form to the top of cupcakes and a cover which can be placed over the top surface of the cupcakes to provide protection for the baked good or placed underneath as a serving and display platform;

FIG. 2 is a perspective view of the same embodiment of three parts of the cupcake pan shown in FIG. 1, displayed in a baking configuration;

FIG. 3 is a perspective view of three parts of the cupcake pan shown in FIG. 1, shown in its serving or display configuration, including a representation of the resulting baked good;

FIG. 4 is a perspective view of a cupcake pan embodiment according to the present invention, having a bottom supporting part that has an integrated perimeter wall with a solid bottom and a reversed view showing the underside of the same supporting part;

### DETAILED DESCRIPTION

The use of the term “cupcake” or “cupcakes” shall also designate any other baked or un-baked item may be prepared, displayed, or otherwise interact with the present invention. The term shall not be construed as limiting. Many other uses for the invention is obvious to one skilled in the art, including decorative and construction applications.

The detailed description set forth below in connection with the appended drawings, where like numerals reference like elements, is intended only as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangable with other steps, or combinations of steps, in order to obtain the same or substantially similar result.

The present invention is directed to pan for baking batters or doughs to provide baked goods such as cupcakes or muffins. The batters or doughs baked either in or on the pan of the present invention typically have a leavening agent as an ingredient. It shall be clear to one with ordinary skill in the art that other ingredients, batters, and baking recipes may also be used.

The pan of the present invention modifies the shape of the baked good to create a combined rectangular surface to allow decoration and ease of transport and serving. The characteristics that are provided to the cupcakes by the pan are generally physical characteristics, such as shape of the product (typically the top surface or cap), symmetry of the product, and maximum baked height.

The pan of the present invention has a perimeter wall that extends above the dividing edges of the pan. The perimeter wall extends above the level of the batter or dough in the pan and extends above the preferred level of the final baked product in the pan. The perimeter wall creates a form to create the shape of the merged top surface. The pan of the present invention includes a plurality of receptacles, each having a round bottom to accomodate paper cupcake liners of many different sizes and shapes. The embodiments discussed herein are described with a standard sized two inch by one an one fourth inch, although any the present invention can be utilized for any size and shape cupcake liner, or none at all. The top of each receptacle may be square in shape and allows close contact between the individual cupcakes. One benefit is to allow the even creation of the merged top surface of the cupcakes which can create even edges when the cupcakes are removed from the merged top surface. Another advantage is to minimize contact points with the pan to reduce the possibility of cupcakes sticking to the pan surfaces.

Although the pan of the present invention can be a pan for baking any items such as muffins or cupcakes, the following description is directed to a pan for baking cupcakes therein. It is understood that the features of this cupcake pan can be incorporated into a pan for other bakery items and remain within the scope of this invention. It is also contemplated that the invention described herein may be used for non-baked items, non-edible items, construction applications, among many other applications.

### DETAILED DESCRIPTION OF THE DRAWINGS

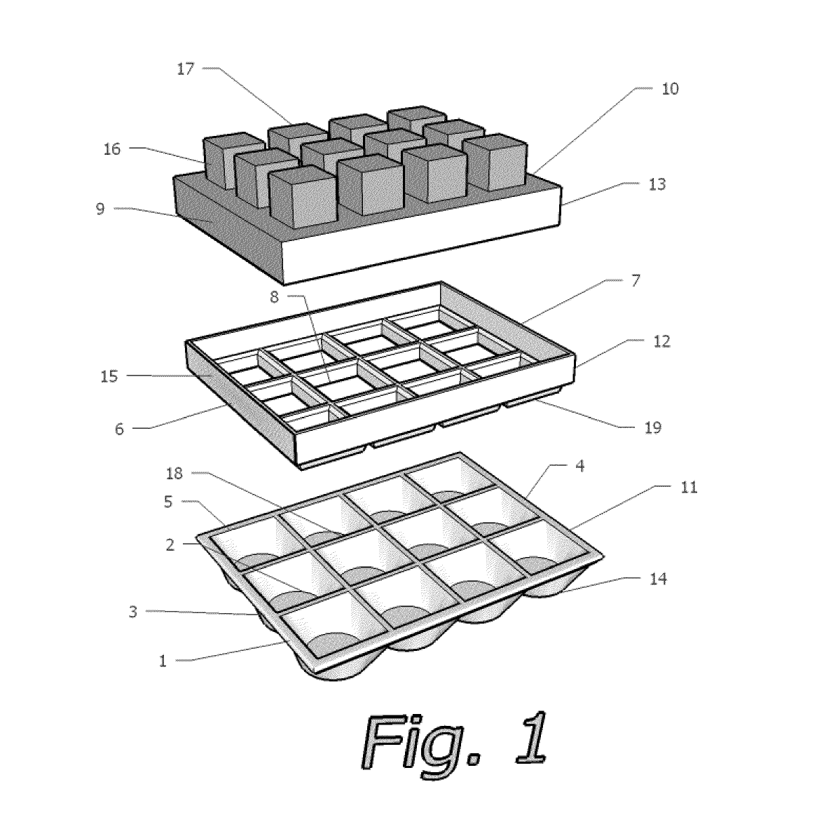

Referring now to the Figures, two embodiments of a cupcake pan according to the present invention are shown. In FIG. 1, lower pan part 11 is a support for the cupcake bottom while cooking, providing the proper form to the cupcakes and may have an extended outer edge to provide for easy grasping 1, a bottom surface 2, a first end 3 and a second end 4 opposite from first end 2. Lower pan part 11 has a plurality of receptacles 14, sized and shaped to hold an amount of cupcake batter and to retain the cupcake once baked. The portion of receptacles 14 positioned farthest from top outer surface 5 defines bottom surface 2; these bottom surfaces may be parallel to top outer surface 5. The bottom surface 2 of receptacles 14 are round in shape to accomodate paper cupcake liners of a size and shape. Positioned between receptacles 14 are dividing edges 18. Top outer surface 5 comprises and is defined by dividing edges 18 and top outer surface 5. The dividing edges 18 are arranged in squares or rectangle to allow close contact between the individual cupcakes, to allow the even creation of the merged top surface, to create even edges when the cupcakes are removed from the merged top surface and to minimize contact points with the pan to reduce the possibility of cupcakes sticking to the pan surfaces. An outer edge of lower pan part 11 is defined by top outer surface 5. Lower pan part 11 has twelve receptacles 14, arranged in three rows, each row having four receptacles 14, extending from first end 3 to second end 4.

In FIG. 1, middle pan part 12 is a support for the cupcake top while cooking, providing the proper form to create the merged top surface of the cupcakes and has a perimeter wall 15 that extends above the top surface of the face of the pan. Middle pan part 12 has a plurality of receptacles 8, sized and shaped match the surface of lower pan part 11 defined by top outer surface 5 and dividing edges 18, although other configurations are contemplated. The bottom portion of receptacles 8 comprises of flanges 19; these flanges are sized and shaped as squares or similar shapes to fit over dividing edges 18. Middle pan part 12 is sized and shaped to nest on top of lower pan part 11 with flanges 19 sized and angled to extend inside receptacles 14. Flanges 19 are angled and of sufficient width to support the cupcake bottom and allow the cupcakes and the merged top surface to be lifted out of lower pan part 11. Middle pan part 12 may have twelve openings separated by dividing edges 18, arranged in three rows, each row having four holes, extending from first end 6 to second end 7. In other embodiments, the number of holes and configurations can vary.

In FIG. 1, pan cover 13 is a cover for a cupcake merged top surface after cooking, provides a means of removing the cupcakes from middle pan part 12 and provides a means of display for the finished cupcakes. Pan cover 13 has a first end 9 and a second end 10 opposite from first end 9. Pan cover 13 has a plurality of protrusions 16, which are sized to fit through the openings formed by the flanges 19, and of sufficient height to support the cupcakes above the level of the perimeter wall 15 while in display mode. Other embodiments may support the cupcakes higher or lower than the perimeter wall. Height may also be user-adjustable. The top surface 17 of protrusions 16 comprise a top surface of pan cover 13. The bottom opening of pan cover 13 is sized to fit over perimeter wall 15 when in cover mode. Pan cover 13 may have twelve protrusions 16, arranged in three rows, each row having four protrusions 16, extending from first end 9 to second end 10. In other embodiments, the number of protrusions may vary. The number of protrusions will usually match the number of the cupcake configuration allowed by the lower pan part and the middle pan part.

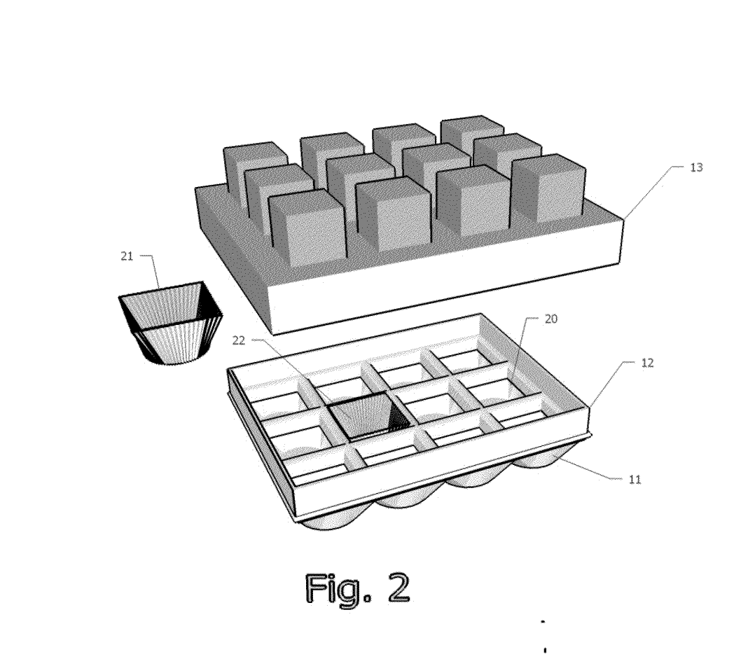

In FIG. 2, lower pan part 11 and middle pan part 12 are shown in a baking configuration. Middle pan part 12 nests on top of lower pan part 11. When assembled, a combined receptacle 20 is created and paper cupcake liners 21 are placed inside combined receptacles 20. After paper cupcake liners 21 are placed inside combined receptacles 20, combined receptacles 20 are prepared for filling as in 22. After each receptacle has a liner placed inside and the liner is filled with the proper portion of dough or batter, the pan assembly (lower pan part 11 and middle pan part 12 into the baking configuration) is ready for baking. Pan cover 13 is not used in the baking process and is shown here ready to be placed on top to cover the completed baked good. In other embodiments, the pan cover may be used in the baking step.

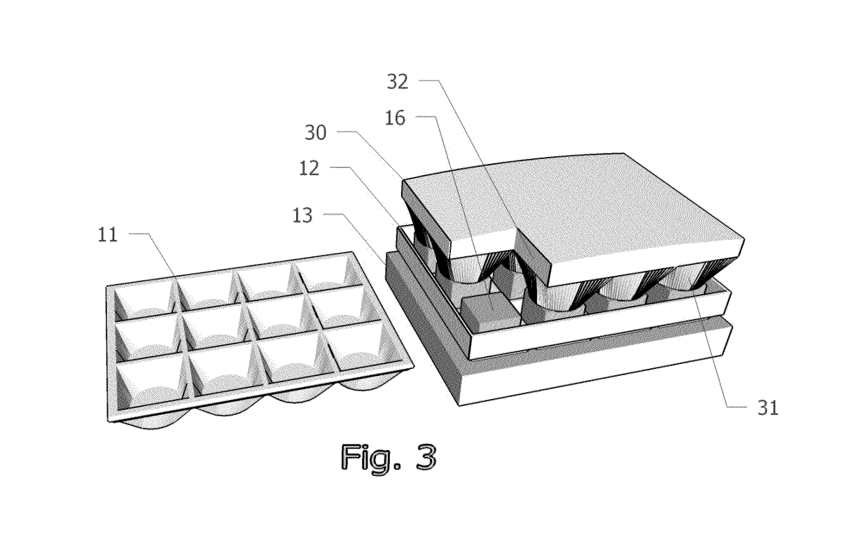

FIG. 3 shows the completed baked good 30, lower pan part 11, middle pan part 12, and pan cover 13 in the display configuration. After baking, middle pan part 12 and the completed baked good 30 are lifted out of pan part 11 and are placed on top of pan cover 13, the circular cupcake bottoms are arranged to center cupcake bottoms 31, on pan cover protrusions 16. Middle pan part 12 is then slid down over pan cover protrusions 16, leaving the completed baked good 30, free from middle pan part 12 and supported by protrusions 16. The merged top surface of the baked good may be decorated while lower pan part 11 and middle pan part 12 are in the prior baking configuration as shown in FIG. 2 or it may be decorated while in the display configuration shown in FIG. 3. After decoration, cupcakes may be removed from the display individually with a simple lifting motion as in 32. Note that no knife or serving utensil is required to remove cupcakes from the display configuration.

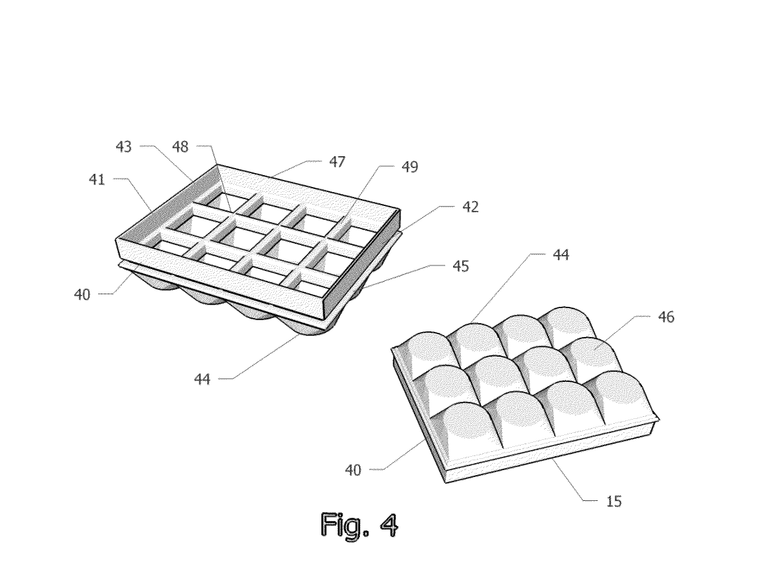

FIG. 4 shows another embodiment of the present invention. In this embodiment, the functions of lower pan part 11 and middle pan part 12 from FIG. 1 of the first embodiment are combined into a single unit pan 40, shown here both upright and inverted, providing the proper form to the cupcakes, having a perimeter wall 43 that extends above the top surface of the face of the pan 40 to create a merged top surface of the cupcakes and has an extended outer edge 45 to provide for easy grasping. Single unit pan 40 has a plurality of receptacles 48, sized and shaped to hold an appropriate amount of cupcake batter and to retain the cupcakes once baked. Bottom surface 46 of receptacles 48 are round in shape to accomodate paper cupcake liners of size and shape commonly available (e.g. Two inch), as well as other possible sizes, smaller, larger, and of different shapes. Positioned between receptacles 48 are dividing edges 49. The dividing edges 49 are arranged in squares to allow close contact between the individual cupcakes, to allow the even creation of the merged top surface, to create even edges when the cupcakes are removed from the merged top surface and to minimize contact points with the pan to reduce the possibility of cupcakes sticking to the pan surfaces, among other benefits clear to one with reasonable skill in the art. An outer edge of single unit pan 40 is defined by top outer surface 47. Single unit pan 40 has twelve receptacles 48. Other embodiments can vary in number and arrangement of receptacles. As in the previous embodiment, paper cupcake liners are inserted into receptacles 48, filled with a proper portion of dough or batter and baked. Differing from the previous embodiment, cupcakes are removed from single unit pan 40 by inverting the pan and baked good onto a plate, single unit pan 40 is lifted off, a plate suitable for display may be placed inverted on top of the inverted cupcakes then both plates and the baked good are inverted again. Single unit pan 40 inverted, may be used as a plate suitable for display. After removing the top plate, the baked good may be decorated with edible and/or inedible items.

Referring to FIGS. 1, 2, 3 and 4, the pan embodiments of which each have twelve receptacles may be created with differing numbers and sizes of receptacles of a proper size to accomodate different standard sizes of paper cupcake liners. The number of rows of receptacles and the number of receptacles in each row may be adjusted to accomodate the correct number of receptacles such that a volume of a recipe of cake batter will fill the receptacles to a proper level and allow the merged top surface to have a rectangular shape of reasonable dimensions for decorating.

The principles, representative embodiments, and modes of operation of the present disclosure have been described in the foregoing description. However, aspects of the present invention are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes and equivalents fall within the spirit and scope of the claimed subject matter.

1. A baking pan comprised of:
a lower pan part and a middle pan part;
the lower pan part having a grid of receptacles
the receptacles of the lower pan part having square top openings;
the receptacles of the lower pan part having closed, circular bottoms;
the receptacles of the lower pan part having side walls connecting the square top openings to the circular bottoms;
the receptacles of the lower pan part being adapted to accomodate a cupcake liner of a standard size;
the middle pan part containing a grid dividing the middle pan part into square receptacles in equal number to the receptacles of the lower pan part;
the receptacles of the middle pan part being adapted to match the openings of the lower pan part;
the bottom of the receptacles may have a side wall that may extend partly into the receptacles of the lower pan part;
the receptacles of the middle pan part having a bottom opening;
the middle pan part having a side wall connected to the outer edge of the grid of receptacles extending above the top of the receptacles;
the side wall of the middle pan part being adapted to provide a form for the creation of a merged top surface of cupcakes during baking.

2. The baking pan of claim 1 further comprising:
A pan cover having a rectangular side wall adapted to fit a top edge of the middle pan part;
the pan cover having a ridge or other means to retain the cover on the top edge of the lower pan part;
the pan cover having protuberances adapted to pass through the bottom openings of the square receptacles of the middle pan part.

3. The baking pan of claim 2 further comprising:
the middle pan part and the lower pan part merged into a combined unit pan;
the combined unit pan allowing the removal of baked cupcakes from the pan by inversion.

4. A method for making and serving cupcakes comprising:
Providing a middle pan part and a lower pan part;
The middle pan part having a grid, the grid forming receptacles;
the middle pan part having a sidewall to shape the cupcake tops into a merged top surface;
placing the middle pan part on top of the lower pan part;
filling each receptacle with a cupcake sleeve;
filling each cupcake sleeve with batter;
baking the cupcakes;
lifting middle pan part;
placing middle pan part on an inverted lower pan part or flat surface.

5. A method for making and serving cupcakes further comprising:
using the method of claim 4 to bake cupcakes having a merged top surface;
creating a shared decoration on multiple cupcakes by decorating the merged top surface of the cupcakes;
placing a cover over the middle pan part and the lower pan part to protect the cupcakes during transport or storage;
the cover having an array of display pedestals;
removing the cover and placing it in the desired display or serving area;
removing the middle pan part from the bottom pan part;
placing the middle pan part on top of the array of display pedestals;
pushing the middle pan part down over the display pedestals to display and serve the decorated cupcakes.

6. a method of making and decorating cupcakes comprised of:
Providing a combined unit pan having a grid, the grid forming receptacles;
the baking pan having a sidewall to shape the cupcake tops into a merged top surface;
filling each receptacle in of the baking pan with a cupcake sleeve;
filling each cupcake sleeve with batter;
baking the cupcakes;
placing a plate or other flat surface over the pan;
inverting the pan and plate to remove the cupcakes;
placing another plate over the bottom of the cupcakes;
inverting the cupcakes again;
decorating the top surface of the cupcakes.
